(19) United States
(12) Patent Application Publication
(10) Pub. No.: US 2020/0285744 A1
(43) Pub. Date: Sep. 10, 2020

(54) INFORMATION PROCESSING APPARATUS, FUNCTION EXECUTABILITY DETERMINATION METHOD AND NON-TRANSITORY COMPUTER-READABLE RECORDING MEDIUM ENCODED WITH FUNCTION EXECUTABILITY DETERMINATION PROGRAM

(71) Applicant: Konica Minolta, Inc., Tokyo (JP)

(72) Inventor: Shinya Hashimoto, Nishinomiya-shi (JP)

(73) Assignee: Konica Minolta, Inc., Tokyo (JP)

(21) Appl. No.: 16/800,435

(22) Filed: Feb. 25, 2020

(30) Foreign Application Priority Data
Mar. 6, 2019 (JP) 2019-041052

(51) Int. Cl. G06F 21/56; G06F 21/74

(52) U.S. Cl. CPC G06F 21/566; G06F 2221/033; G06F 21/74; G06F 21/567

(57) ABSTRACT

An information processing apparatus includes: a hardware processor that: confirms whether a program is registered in a whitelist; estimates whether the program is risky of causing infection with a computer virus; determines whether the program that has been confirmed as registered but estimated as risky is present in a function requested by a user; and upon determining that the program that has been confirmed as registered but estimated as risky is present in the function, determines whether to execute the function based on one or more processes defined by the function.

### CROSS-REFERENCE TO RELATED APPLICATION

The entire disclosure of Japanese patent Application No. 2019-041052 filed on Mar. 6, 2019, is incorporated herein by reference.

### BACKGROUND

### Technical Field

The present invention relates to an information processing apparatus, a function executability determination method and a non-transitory computer-readable recording medium encoded with a function executability determination program. In particular, the present invention relates to an information processing apparatus including a check function for a computer virus, a function executability determination method executed in the information processing apparatus and a non-transitory computer-readable recording medium encoded with a function executability determination program for causing a computer to execute the function executability determination method.

### Description of the Related Art

An information processing apparatus such as a Multi-Function Peripheral (hereinafter referred to as an “MFP”) may perform a process on data received from outside. For example, the MFP may download data from a computer connected to the Internet for processing. In this case, the MFP is exposed to the threat of a computer virus. Therefore, there are MFPs having a check function of verifying a risk of data, received from the MFP, causing infection with a computer virus. In the meantime, an MFP may have a whitelist in which programs that are confirmed to be safe in regards to computer viruses are registered, but there may be cases where a program registered in the whitelist carries a risk of causing infection with a computer virus.

The technique for verifying presence of a computer virus using a plurality of databases has been known. For example, Japanese Patent No. 4554675 describes a communication control device including a storage that stores a plurality of reference data pieces that can be used as reference for determination on whether an access to the contents held at an accessible position through the network is permitted or prohibited, a searcher that acquires communication data for requesting an access to the contents and searches in the communication data for reference data and a search circuit that determines whether the communication data includes any of the reference data stored in a database, and employs the result of determination in regards to a database having a higher priority among results of determination carried out in parallel by a plurality of the search circuits.

However, in the communication control device described in Japanese Patent No. 4554675, in the case where the results of determination carried out in parallel by the plurality of the search circuits are different, the result of determination in regards to a database having a higher priority is employed. However, the result of determination in regards to a database having a lower priority is not employed. Therefore, a risk of computer viruses cannot be avoided.

### SUMMARY

According to one or more embodiments of the present invention, an information processing apparatus includes a hardware processor, wherein the hardware processor confirms safety of a program in regards to a computer virus, estimates a risk of the program causing infection with the computer virus, and in the case where execution of a function defining a combination of one or more programs is requested, when a program that is confirmed to be safe and estimated to be risky is present among one or more programs defined by the function, determines whether the function is to be executed based on one or more processes defined by the function.

According to one or more embodiments of the present invention, a function executability determination method of causing an information processing apparatus to execute a confirming step of confirming safety of a program in regards to a computer virus, a risk estimating step of estimating a risk of the program causing infection with the computer virus, and a determining step of, in the case where execution of a function defining a combination of one or more programs is requested, when the program that is confirmed to be safe in the confirming step and estimated to be risky in the risk estimating step is present among the one or more programs defined by the function, determining whether the function is to be executed based on one or more processes defined by the function.

According to one or more embodiments of the present invention, a non-transitory computer-readable recording medium is encoded with a function executability determination program for causing a computer to execute a confirming step of confirming safety of a program in regards to a computer virus, a risk estimating step of estimating a risk of the program causing infection with the computer virus, and a determining step of, in the case where execution of a function defining a combination of one or more programs is requested, when the program that is confirmed to be safe in the confirming step and estimated to be risky in the risk estimating step is present among the one or more programs defined by the function, determining whether the function is to be executed based on one or more processes defined by the function.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing the appearance of an MFP according to one or more embodiments of the present invention;

FIG. 2 is a block diagram showing the outline of a hardware configuration of the MFP according to one or more embodiments of the present invention;

FIG. 3 is a block diagram showing one example of functions of a CPU included in the MFP according to one or more embodiments of the present invention;

FIG. 4 is a flow chart showing one example of a flow of a function executability determination process according to one or more embodiments of the present invention;

FIG. 5 is a flow chart showing one example of a flow of an executability determination process according to one or more embodiments of the present invention;

FIG. 6 is a flow chart showing one example of a flow of a definition file update process according to one or more embodiments of the present invention;

FIG. 7 is a block diagram showing one example of functions of a CPU included in an MFP in a modified example of one or more embodiments of the present invention;

FIG. 8 is a diagram showing one example of a level table according to one or more embodiments of the present invention;

FIG. 9 is a flow chart showing one example of a flow of a function executability determination process in the modified example of one or more embodiments of the present invention; and

FIG. 10 is a flow chart showing one example of a flow of a prohibited type determination process according to one or more embodiments of the present invention.

### DETAILED DESCRIPTION OF EMBODIMENTS

Hereinafter, embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Thus, a detailed description thereof will not be repeated.

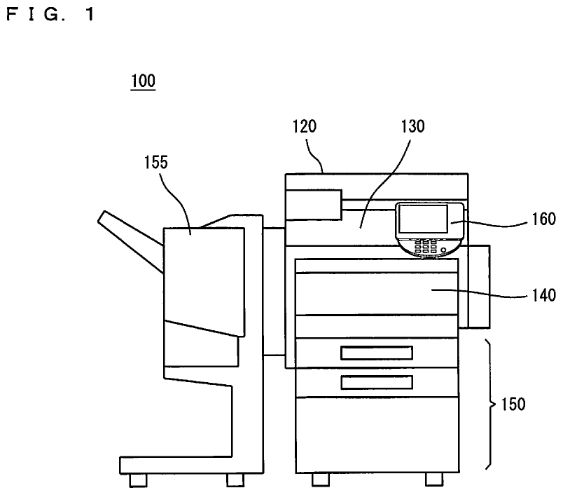

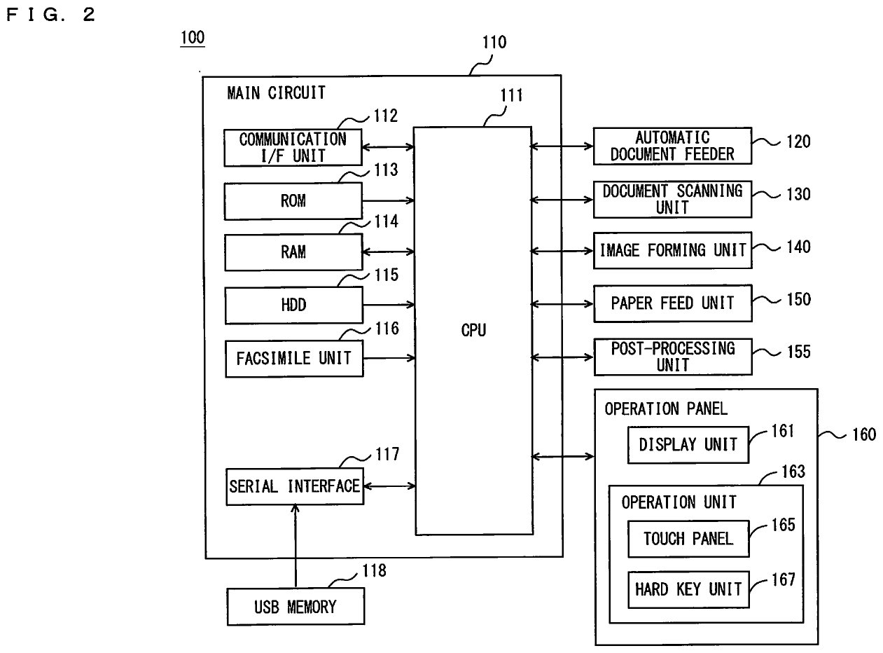

FIG. 1 is a perspective view showing the appearance of an MFP according to one or more embodiments of the present invention. FIG. 2 is a block diagram showing the outline of the hardware configuration of the MFP according to one or more embodiments. Referring to FIGS. 1 and 2, the MFP 100 functions as an information processing apparatus and includes a main circuit 110, a document scanning unit 130 for scanning a document, an automatic document feeder 120 for conveying a document to the document scanning unit 130, an image forming unit 140 for forming an image on a paper (a sheet of paper) based on image data that is output by the document scanning unit 130 that has scanned a document, a paper feed unit 150 for supplying a paper to the image forming unit 140, a post-processing unit 155 for processing a paper on which an image is formed and an operation panel 160 serving as a user interface.

The post-processing unit 155 performs a sorting process of sorting and discharging one or more papers on which images have been formed by the image forming unit 140, a punching process of punching the papers and a stapling process of stapling the papers.

The main circuit 110 includes a CPU (or hardware processor) 111, a Communication Interface (I/F) unit 112, a ROM 113, a RAM 114, a Hard Disk Drive (HDD) 115 as a mass storage, a facsimile unit 116 and a serial interface 117 to which a USB memory 118 is attached. The CPU 111 is connected to the automatic document feeder 120, the document scanning unit 130, the image forming unit 140, the paper feed unit 150, the post-processing unit 155 and the operation panel 160, and controls the entire MFP 100.

The ROM 113 stores a program executed by the CPU 111 or data necessary for execution of the program. The RAM 114 is used as a work area when the CPU 111 executes a program. Further, the RAM 114 temporarily stores image data successively transmitted from the document scanning unit 130.

The communication I/F unit 112 is an interface for connecting the MFP 100 to a network. The CPU 111 communicates with a computer connected to the network through the communication I/F unit 112, and transmits data to and receive data from the computer. Further, the communication I/F unit 112 can communicate with a computer connected to the Internet through the network.

The facsimile unit 116 is connected to the Public Switched Telephone Networks (PSTN) and transmits facsimile data to or receives facsimile data from the PSTN. The facsimile unit 116 stores the received facsimile data in the HDD 115 or outputs the data to the image forming unit 140. The image forming unit 140 prints the facsimile data received by the facsimile unit 116 on a paper. Further, the facsimile unit 116 converts the data stored in the HDD 115 into facsimile data, and transmits the facsimile data to a facsimile machine connected to the PSTN.

The serial interface 117 is an interface for performing serial communication with an external device. Here, the serial communication supports the USB (Universal Serial Bus) standard. An external device that is communicable utilizing the USB standard can be connected to the serial interface 117. The CPU 111 can access the external device through the serial interface 117. The external device includes an external storage device such as a USB memory 118 or a CD drive.

Here, the external device is the USB memory 118 by way of example. The USB memory 118 includes a semi-conductor memory such as an EPROM (Erasable Programmable ROM), and a serial communication circuit. The CPU 111 can read out the data recorded in the USB memory 118 attached to the serial interface 117 and can write data into the USB memory 118. Further, the CPU 111 loads the program stored in the USB memory 118 into the RAM 114 for execution.

It is noted that the medium for storing the program executed by the CPU 111 is not restricted to the USB memory 118. It may be an optical disc (a CD-ROM (Compact Disk ROM), an MO (Magnetic Optical Disc)/an MD (a mini disc)/a DVD (Digital Versatile Disc)), an optical card or a mask ROM.

Further, the program executed by the CPU 111 is not restricted to the program recorded in the USB memory 118. The CPU 111 may load the program, stored in the HDD 115, into the RAM 114 for execution. In this case, another computer connected to the network may rewrite the program stored in the HDD 115 of the MFP 100, or may additionally write a new program therein. Further, the MFP 100 may download a program from another computer connected to the network, and store the program in the HDD 115. The program referred to here includes not only a program directly executable by the CPU 111 but also a source program, a compressed program, an encrypted program or the like.

The operation panel 160 is provided on the upper surface of the MFP 100 and includes a display unit 161 and an operation unit 163. The display unit 161 is a Liquid Crystal Display device (LCD) or an organic EL (Electroluminescence) display, for example, and displays instruction menus to users, information about the acquired image data, and other information. The operation unit 163 includes a touch panel 165 and a hard key unit 167. The touch panel 165 is superimposed on the upper surface or the lower surface of the display unit 161. The hard key unit 167 includes a plurality of hard keys. The hard keys are contact switches, for example. The touch panel 165 detects a position designated by a user on the display surface of the display unit 161.

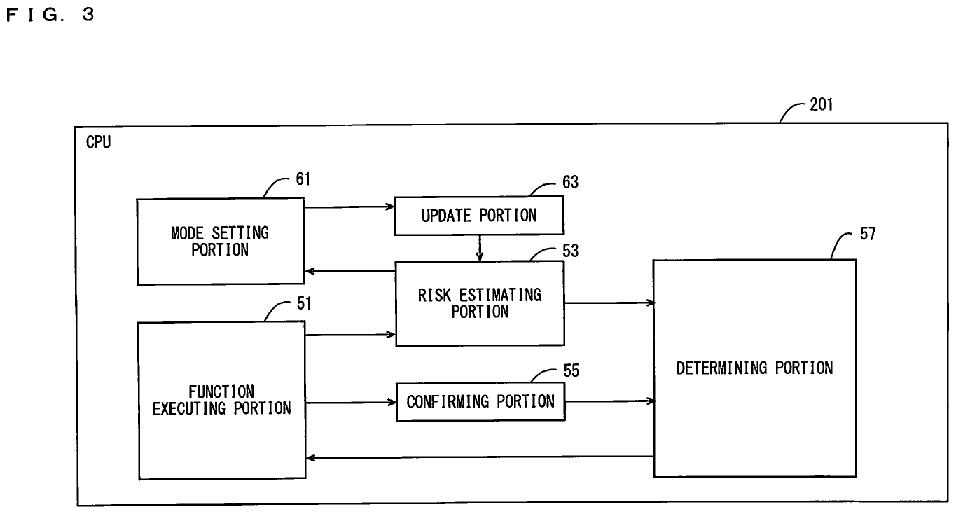

FIG. 3 is a block diagram showing one example of functions of a CPU included in the MFP according to one or more embodiments. The functions shown in FIG. 3 are the functions realized by the CPU 111 when the CPU 111 included in the MFP 100 executes a function executability determination program stored in the ROM 113, the HDD 115 or the USB memory 118. Referring to FIG. 3, the CPU 111 includes a function executing portion 51 for executing functions, a risk estimating portion 53, a confirming portion 55, a determining portion 57, a security level setting portion 59, a mode setting portion 61 and an update portion 63.

The function executing portion 51 executes a requested function in response to a request. A function defines one or more processes. A program defines a process executed by the CPU 111. Therefore, a function defines a program or a combination of programs. The CPU 111 executes one or more processes defined by the function by executing one or more programs defined by the requested function in response to the request for execution of the function. The programs in this case include a plurality of programs included in a library, which is a collection of a plurality of programs. The plurality of programs included in the library include a program defining a function and a subroutine program. Further, the programs include a program for controlling hardware resources and a program for processing data. The hardware resources include the communication I/F unit 112, the HDD 115, the facsimile unit 116, the serial interface 117, the automatic document feeder 120, the document scanning unit 130, the image forming unit 140, the paper feed unit 150, the post-processing unit 155 and the operation panel 160. The program for processing data includes a program for defining a process of outputting data to outside and a program for defining a process of receiving data from outside.

The function executing portion 51 accepts an operation input by the user and accepts a request for executing the function defined by the accepted operation. The function executing portion 51 accepts the operation input by the user who operates the operation unit 163. Further, in the case where the MFP 100 is remotely operated by a portable information device such as a smartphone or a remote operation device such as a personal computer, connected through the communication I/F unit 112, the communication I/F unit 112 receives the information indicating the operation input by the user from the remote operation device when the user operates the remote operation device. The function executing portion 51 accepts the operation specified by the information, which the communication I/F unit 112 receives from the remote operation device.

The function executing portion 51 can execute a plurality of functions. The function executing portion 51 executes a program stored in the HDD 115 in order to execute a plurality of functions. The program to be executed by the function executing portion 51 is defined by the function to be executed. The functions executable by the MFP 100 include a scan function that defines a scan process of controlling the document scanning unit 130 and scanning a document, an image forming function that defines an image formation process of controlling the image forming unit 140 and the paper feed unit 150 and forming an image on a paper, a data transmission function for controlling the communication I/F unit 112 and transmitting data to outside, a data reception function for controlling the communication I/F unit 112 and receiving data from outside, a facsimile function for controlling the facsimile unit 116 and transmitting and receiving facsimile data and a data management function that defines a data management process of controlling the HDD 115, storing data, deleting data, etc.

There are a plurality of data transmission functions due to differences in transmission protocol. For example, the data transmission functions include the function that defines a mail transmission process of transmitting data using an email protocol, the function that defines an SMB transmission process of transmitting data using an SMB (Server Message Block) protocol, the function of defining an FTP transmission process of transmitting data using an FTP (File Transfer Protocol) and the function that defines a browsing process of accessing a web server using an HTTP (Hypertext Transfer Protocol).

There are a plurality of data reception functions due to differences in reception protocol. For example, the data reception functions include the function that defines a mail reception process of receiving data using the email protocol, the function that defines an SMB reception process of receiving data using the SMB protocol, the function that defines an FTP reception process of receiving data using the FTP and the browsing function of defining the browsing process of downloading a web page from a web server using the HTTP. Further, the data reception function includes a print file reception process of receiving a print file from a computer.

The facsimile function includes the function that defines a FAX transmission process of transmitting data using a facsimile protocol and the function that defines a FAX reception process of receiving data using the facsimile protocol.

The data management function includes the function that defines a USB output process of writing data into the USB memory 118 and the function that defines a USB input process of reading data stored in the USB memory 118.

Further, the function executable by the MFP 100 includes the function that is a combination of a plurality of processes. Specifically, the function includes a copy function that is a combination of the scan process and the image formation process, a print function that is a combination of the data reception process and the image formation process, a scan transmission function that is a combination of the scan process and the data transmission process and a scan saving function of saving the data that is acquired by a combination of the scan process and the data management process.

Further, in addition to the program stored in the HDD 115, the function executing portion 51 may execute a program received from outside. For example, the function executing portion 51 may receive a program together with a web page received from a web server in the case where the browsing process is executed, and the function executing portion 51 executes the program that is received together with the web page. Therefore, the program includes a program embedded in data.

The risk estimating portion 53 estimates whether the program has a risk of causing infection with a computer virus based on a definition file acquired from a predetermined server. The program the risk of which is to be estimated by the risk estimating portion 53 is a program to be executed by the function executing portion 51. In addition to the programs stored in the HDD 115, a program to be executed by the function executing portion 51 includes a program received from outside. The risk estimating portion 53 outputs a result of risk estimation to the determining portion 57. The result of estimation includes program identification information for identifying a program, and presence and absence of a risk. The risk estimating portion 53 is a function formed in the CPU 111 when the CPU 111 executes an anti-virus program.

The confirming portion 55 confirms the safety of a program in regards to computer viruses based on a whitelist. The whitelist is a list of programs that have been confirmed to be safe against computer viruses, and stored in the HDD 115 in advance. The whitelist is created by the manufacturer of the MFP 100 and provided by the manufacturer that provides the MFP 100. The whitelist is downloaded from a server managed by the manufacturer that provides the MFP 100, and stored in the HDD 115. A program registered in the whitelist is a program executed by the CPU 111, so that the function executing portion 51 can execute a function. The program the safety of which is to be confirmed by the confirming portion 55 includes a program received from outside in addition to the programs stored in the HDD 115. The confirming portion 55 outputs the result of safety confirmation to the determining portion 57. The result of confirmation includes program identification information for identifying a program, and presence and absence of safety.

In the case where a program, that is confirmed to be safe according to the result of confirmation (i.e., is confirmed to be registered on the whitelist) but estimated to be risky according to the result of estimation, is determined to be present among the one or more programs defined by the requested function before the function executing portion 51 executes the requested function, the determining portion 57 determines whether the function is to be executed based on the one or more processes defined by the function.

The determining portion 57 determines that the function is to be executed in the case where the one or more processes defined by the function do not include a process of a predetermined type. The determining portion 57 determines that the function is not to be executed in the case where the one or more processes defined by the function include a process of a type that indicates prohibition of execution. The determining portion 57 outputs the result of determination to the function executing portion 51. Hereinafter, the type that represents processes the execution of which is prohibited is referred to as a prohibited type. The prohibited type is predetermined according to an operation input by the user who manages the MFP 100.

A process of the prohibited type includes a process that may cause infection with a computer virus to spread and a process that may cause infection with a computer virus. The process that may cause infection with a computer virus to spread includes a process of outputting data to outside. When the data is output to outside in the case where the MFP 100 is infected with a computer virus, the device that receives the data is highly likely to become infected with the computer virus. Therefore, it is possible to prevent infection with a computer virus from spreading by not executing the process of outputting data to outside. The process of outputting the data to outside is a process defined by the data transmission function. Specifically, the process of outputting data to outside includes the mail transmission process, the FAX transmission process, the FTP transmission process, the SMB transmission process, the browsing process and the USB output process.

The process that may cause infection with a computer virus includes a process of receiving data from outside. The process of receiving data from outside includes a process defined by the data reception function. Specifically, the process of receiving data from outside includes the print file reception process, the mail reception process, the FAX reception process, the FTP reception process, the SMB reception process, the browsing process and the USB input process.

The function executing portion 51 executes the requested function in the case where the determination result received from the determining portion 57 indicates permission to execute the function. However, in the case where the determination result received from the determining portion 57 indicates prohibition against execution of the function, the function executing portion 51 does not execute the requested function.

The risk estimating portion 53 registers a program that is estimated to be risky of causing infection, i.e., estimated to carry a risk of causing infection with a computer virus in a check list. In the case where a program is registered in the check list, the risk estimating portion 53 estimates whether the program registered in the check list has a risk causing infection with a computer virus based on an updated definition file in response to an update of the definition file by the update portion 63. The risk estimating portion 53 deletes the program that is estimated to carry no risk of causing infection with a computer virus from the check list.

The mode setting portion 61 sets an update mode to a first mode or a second mode that is different from the first mode. The mode setting portion 61 sets the update mode to the second mode when the MFP 100 is in a default state, for example, a state in which the MFP 100 is in when the MFP 100 is powered on. The mode setting portion 61 switches the update mode to the first mode when a program is registered in the check list with the update mode being set to the second mode. The mode setting portion 61 sets the update mode to the second mode when the program registered in the check list is removed from the check list with the update mode being set to the first mode.

The update portion 63 acquires a definition file from a predetermined server. The definition file is computer virus definition data recording the features of a program that carries a risk of causing infection with a computer virus, and is used for estimating a risk of the program by the risk estimating portion 53. The point in time at which the update portion 63 acquires a definition file differs depending on the update mode set by the mode setting portion 61. The update portion 63 inquires the predetermined server whether a definition file has been updated. If the definition file has been updated by the server, the update portion 63 downloads the definition file.

In a period during which the update mode is set to the first mode by the mode setting portion 61, the update portion 63 updates the definition file when a first period of time elapses since the definition file is updated. In a period during which the update mode is set to the second mode by the mode setting portion 61, the update portion 63 updates the definition file at a predetermined certain point in time. The certain point in time is a predetermined point in time or a point in time at which the MFP 100 is powered on. For example, the certain point in time may be 12:00 every day. Further, the certain point in time may be a point in time at which a predetermined second period of time elapses since the definition file is updated. The second period of time is longer than the first period of time.

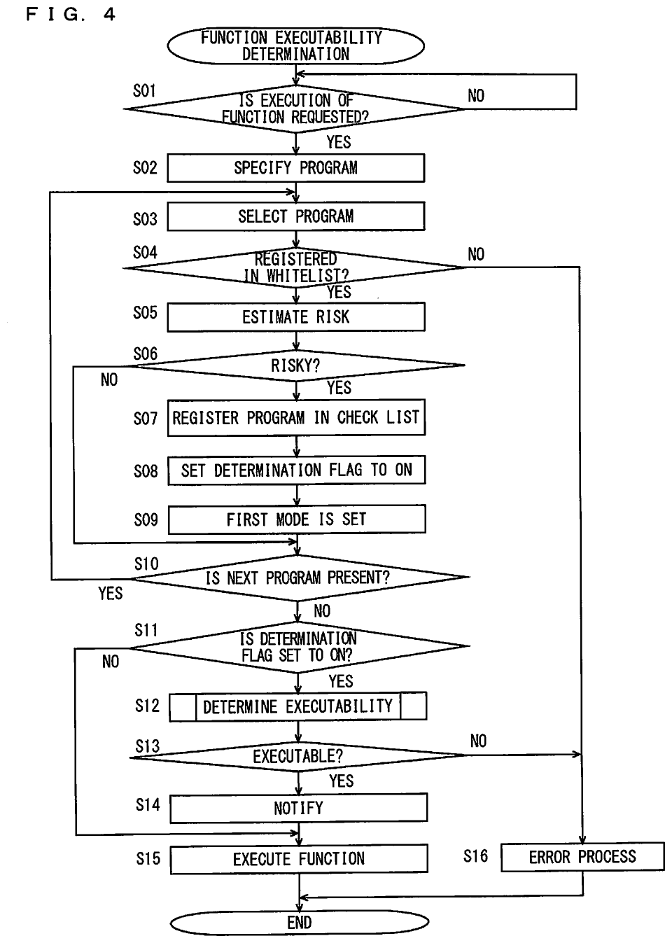

FIG. 4 is a flow chart showing one example of a flow of a function executability determination process according to one or more embodiments. The function executability determination process is a process executed by the CPU 111 when the CPU 111 included in the MFP 100 executes the function executability determination program stored in the ROM 113, the HDD 115 or the USB memory 118. Referring to FIG. 4, the CPU 111 determines whether a request for executing a function has been accepted (step S01). The process waits until the request for executing the function is accepted (NO in the step S01). If the request for executing the function is accepted (YES in the step S01), the process proceeds to the step S02.

In the step S02, one or more programs defined by the function are specified, and the process proceeds to the step S03. In the step S03, a program to be processed is selected from the one or more programs, and the process proceeds to the step S04. In the step S04, the CPU 111 determines whether the program to be processed is registered in the whitelist. If the program to be processed is registered in the whitelist, the process proceeds to the step S05. If not, the process proceeds to the step S16.

In the step S05, the CPU 111 estimates whether the program, to be processed, has a risk of causing infection with a computer virus, and the process proceeds to the step S06. In the step S06, the process branches depending on the result of risk estimation. If it is determined that the program to be processed carries a risk of causing infection with a computer virus, the process proceeds to the step S07. If not, the process proceeds to the step S10.

In the step S16, an error process is executed, and the process ends. The error process is the process of notifying the user of a risk of causing infection with a computer virus. For example, the name for identifying the function requested in the step S01 is displayed in the display unit 161.

In the step S07, the program selected as a program to be processed is registered in the check list, and the process proceeds to the step S08. In the step S08, a determination flag is set to ON, and the process proceeds to the step S09. The determination flag is a flag that defines whether the below-mentioned executability determination process is to be executed. In the case where the executability determination process is to be executed, the determination flag is set to ON. In the step S09, the update mode is set to the first mode, and the process proceeds to the step S10.

In the step S10, the CPU 111 determines whether a program that is not selected in the step S03 as a program to be processed is present. If an unselected program is present, the process returns to the step S03. If not, the process proceeds to the step S11.

In the step S11, the CPU 111 determines whether the determination flag is set to ON. If the determination flag is set to ON, the process proceeds to the step S12. If not, the process proceeds to the step S15.

In the step S12, the executability determination process is executed, and the process proceeds to the step S13. The executability determination process, which will be described below in detail, is the process of determining whether the function requested in the step S01 is executable. In the step S13, the process branches depending on the result of executability determination process. If it is determined that the function is executable, the process proceeds to the step S14. If not, the process proceeds to the step S16.

In the step S13, the user is notified that the function is to be executed, and the process proceeds to the step S14. The user is notified of an error message indicating that the function is to be executed even though the program carrying a risk of causing infection with a computer virus is present. Alternatively, the user may be notified of an error message indicating presence of a risk of causing infection with a computer virus. For example, the name for identifying the function requested in the step S01 or the name for identifying the program that is estimated to carry a risk of causing infection with a computer virus may be displayed in the display unit 161 together with the error message. The process may proceed to the step S15 on the condition that an operation performed by the user who permits execution of the function is accepted. In the step S15, the function is executed, and the process ends. The one or more programs defined by the function are executed by the CPU 111, so that the one or more processes defined by the function are executed.

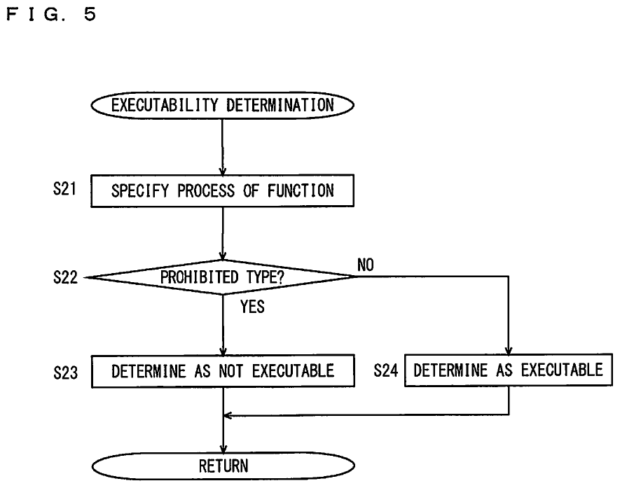

FIG. 5 is a flow chart showing one example of a flow of the executability determination process according to one or more embodiments. The executability determination process is the process executed in the step S10 of the function executability determination process. Before the function executability determination process is executed, the requested function is determined. The CPU 111 specifies the process defined by the requested function in the step S21, and the process proceeds to the step S22. In the step S22, the CPU 111 determines whether the type of a process is the prohibited type. If the type of a process is the prohibited type, the process proceeds to the step S23. If not, the process proceeds to the step S24. In the step S23, the CPU 111 determines that the process is not executable, and the process returns to the function executability determination process. In the step S24, the CPU 111 determines that the process is executable, and the process returns to the function executability determination process.

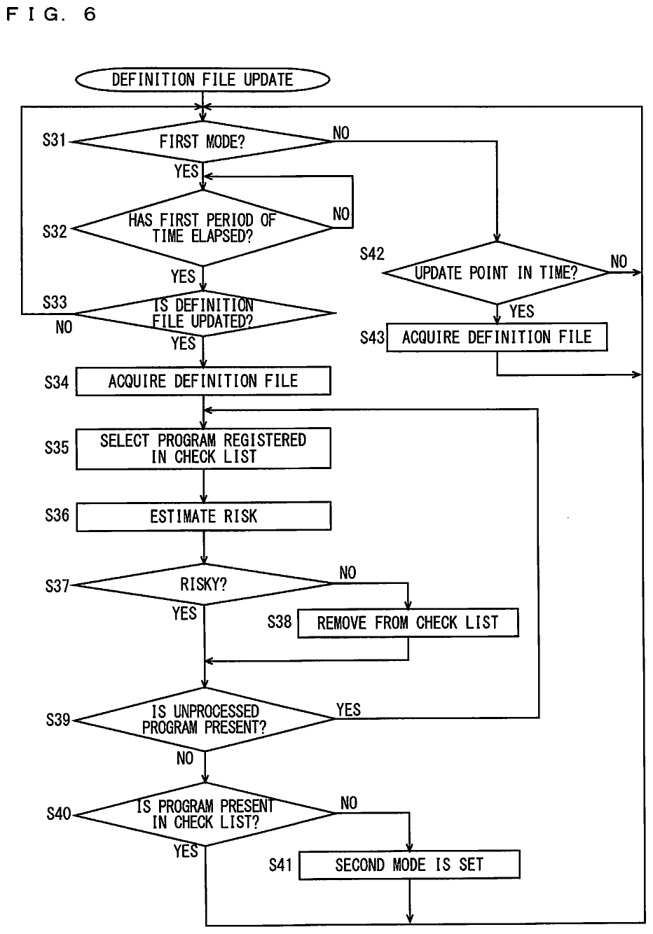

FIG. 6 is a flow chart showing one example of a flow of a definition file update process according to one or more embodiments. The definition file update process is the process executed by the CPU 111 when the CPU 111 included in the MFP 100 executes a definition file update program stored in the ROM 113, the HDD 115 or the USB memory 118. The definition file update program is part of the function executability determination program. Referring to FIG. 6, the CPU 111 determines whether the update mode is set to the first mode. If the update mode is set to the first mode, the process proceeds to the step S32. If not, the process proceeds to the step S42. In the case where the process proceeds to the step S42, the update mode is set to the second mode. In the step S42, the CPU 111 determines whether the current point in time is the update point in time defined for the second mode. If the current point in time is the update point in time, the process proceeds to the step S43. If not, the process returns to the step S31.

In the step S32, the CPU 111 determines whether the first period of time has elapsed. The process waits until the first period of time elapses since the CPU 111 attempts to update the definition file (NO in the step S32). If the first period of time has elapsed since the CPU 111 attempted to update the definition file (YES in the step S32), the process proceeds to the step S33. In the step S33, the CPU 111 determines whether the definition file has been updated in the server from which the definition file is downloaded. If the definition file has been updated, the process proceeds to the step S34. If not, the process returns to the step S31. In the step S34, a definition file is acquired from the server, and the process proceeds to the step S35.

In the step S35, the program to be processed is selected from the programs registered in the check list, and the process proceeds to the step S36. In the step S36, the CPU 111 estimates a risk of the selected program causing infection with a computer virus, and the process proceeds to the step S37. In the step S37, the process branches depending on the result of risk estimation. If it is determined that the specified program carries a risk of causing infection with a computer virus, the process proceeds to the step S39. If not, the process proceeds to the step S38.

In the step S38, the specified program is deleted from the check list, and the process proceeds to the step S39. In the step S39, the CPU 111 determines whether an unprocessed program is present. If a program that is not selected in the step S35 as a program to be processed is present among the programs registered in the check list, the process returns to the step S35. If not, the process proceeds to the step S40.

In the step S40, the CPU 111 determines whether a program is registered in the check list. If a program is registered in the check list, the process returns to the step S31. If not, the process proceeds to the step S41. In the step S41, the update mode is set to the second mode, and the process returns to the step S31.

### First Modified Example

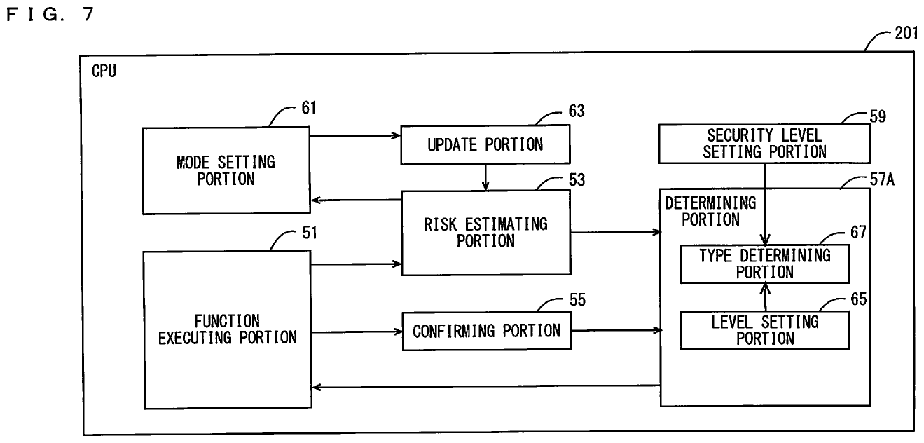

FIG. 7 is a block diagram showing one example of functions of a CPU included in an MFP in the first modified example of one or more embodiments. Referring to FIG. 7, the functions of the CPU included in the MFP in the first modified example are different from the functions shown in FIG. 3 in that a security level setting portion 59 is added, and the determining portion 57 is changed to a determining portion 57A. The other functions are the same as the functions shown in FIG. 3. Thus, a description thereof will not be repeated.

The security level setting portion 59 sets the security level. The security level setting portion 59 sets the security level according to the operation input by the user who manages the MFP 100, for example. The security level setting portion 59 outputs the set security level to the determining portion 57.

The determining portion 57 includes a level setting portion 65 and a type determining portion 67. The level setting portion 65 sets a function level for the type of a process. The level setting portion 65 sets a function level for a type of a process according to an operation input by the user who manages the MFP 100, for example. The level setting portion 65 stores a level table that associates a set function level with each type of a process in the HDD 115.

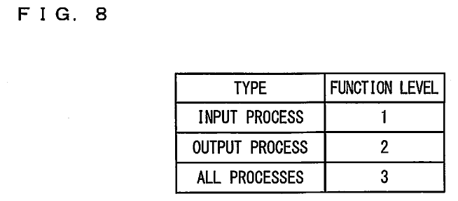

FIG. 8 is a diagram showing one example of the level table according to one or more embodiments. Referring to FIG. 8, the level table includes a level record for each type of a process. The level record includes a “type” field and a “function level” field. In the “type” field, the type identification information for identifying the type is set. In the “function level” field, the function level, set for the type identified by the type identification information and set in the “type” field, is set. In the level table shown in FIG. 8, a function level 1 is associated with the type the type identification information of which indicates an input process, and a function level 2 is associated with the type the type identification information of which indicates an output process, and a function level 3 is associated with the type the type identification information of which indicates all processes. The type “input process” represents the type into which a process of receiving data from outside is classified. The type “output process” represents the type into which a process of outputting data to outside is classified. The type “all processes” represents the type into which all processes executable by the function executing portion 51 are classified into.

Returning to FIG. 7, the type determining portion 67 determines a prohibited type based on the security level set by the security level setting portion 59 with reference to the function level set for each of a plurality of types by the level setting portion 65. The type determining portion 67 determines all of the types having the function level equal to or lower than the security level as prohibited types. Specifically, in the case where the security level is 1, the type determining portion 67 determines the type the type identification information of which represents the “input process” as a prohibited type. In the case where the security level is 2, the type determining portion 67 determines the type the type identification information of which represents the “input process” and the type the type identification information of which represents the “output process” as the prohibited types. In the case where the security level is 3, the type determining portion 67 determines the type the type identification information of which represents the “all processes” as the prohibited type. Further, in the case where the security level is 0, the type determining portion 67 does not determine the type the type identification information of which represents the “all processes” as the prohibited type.

In the case where the one or more processes defined by the function do not include a process of the prohibited type, the determining portion 57A determines that the function is to be executed. In the case where the one or more processes defined by the function include a process of the prohibited type, the determining portion 57A determines that the function is not to be executed. The determining portion 57A outputs the determination result to the function executing portion 51.

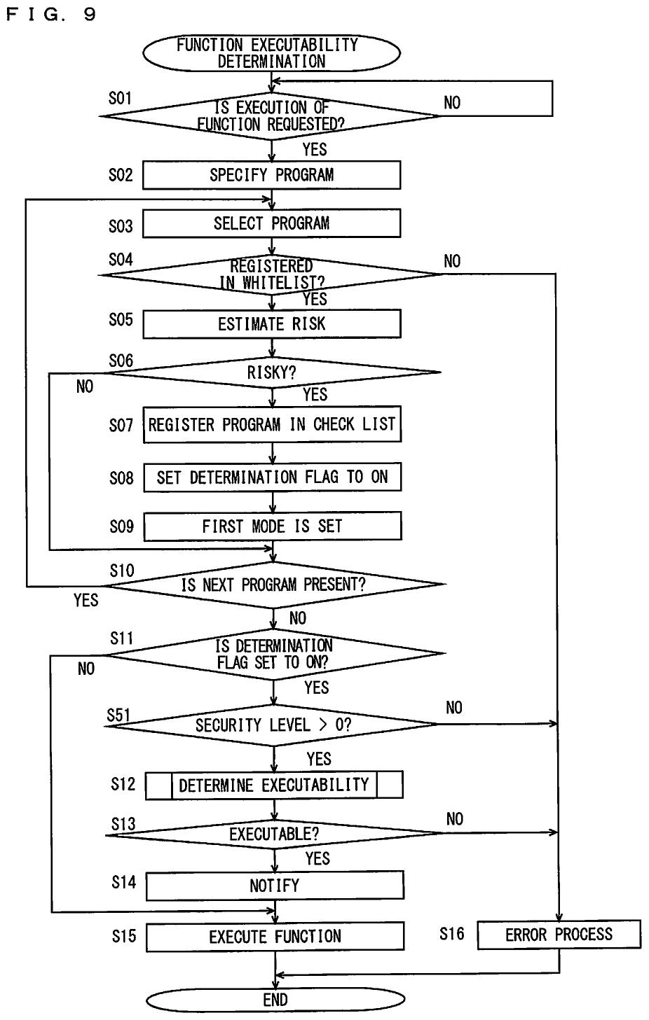

FIG. 9 is a flow chart showing one example of a flow of a function executability determination process in the first modified example of one or more embodiments. Referring to FIG. 9, the function executability determination process in the first modified example is different from the function executability determination process shown in FIG. 4 in that the step S51 is added between the step S11 and the step S12. The other processes are the same as the processes shown in FIG. 4. Therefore, a description thereof will not be repeated.

In the step S51, the CPU 111 determines whether the security level is higher than 0. If the security level is higher than 0, the process proceeds to the step S12. If not, the process proceeds to the step S16.

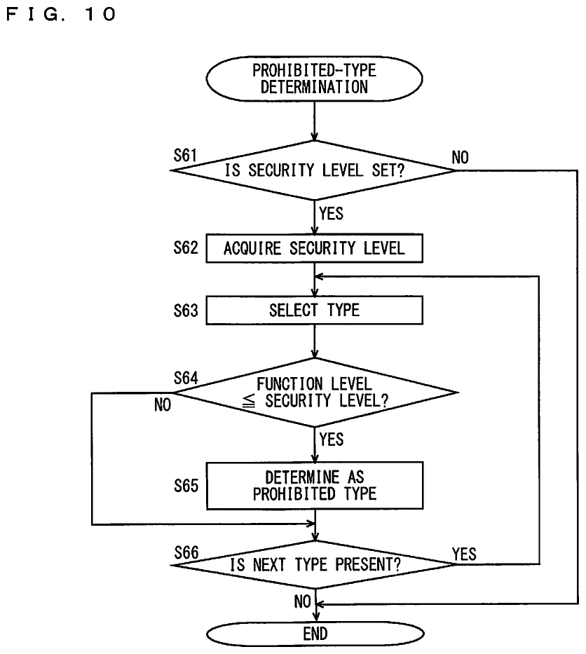

FIG. 10 is a flow chart showing one example of a flow of a prohibited type determination process according to one or more embodiments. The prohibited type determination process is the process executed by the CPU 111 when the CPU 111 included in the MFP 100 executes a prohibited type determination program stored in the ROM 113, the HDD 115 or the USB memory 118. The prohibited type determination program is part of the function executability determination program.

Referring to FIG. 10, the CPU 111 determines whether the security level is set (step S61). The process waits until the security level is set (NO in the step S61). When the security level is set (YES in the step S61), the process proceeds to the step S62.

In the step S62, the security level is acquired. Then, a type of the process is selected (step S63), and the process proceeds to the step S64. In the step S64, the function level defined for the selected type of the process is compared with the security level. If the function level is equal to or lower than the security level, the process proceeds to the step S65. If not, the process proceeds to the step S66. In the step S65, the CPU 111 determines the selected type of the process as the prohibited type, and the process proceeds to the step S66. In the step S66, the CPU 111 determines whether an unselected type of a process is present. If an unselected type of a process is present, the process returns to the step S63. If not, the process ends.

### Second Modified Example

A definition file may be updated each time execution of a function is requested. Further, a definition file may be updated in response to update of the definition file in a server from which the definition file is downloaded.

As described above, the MFP 100 of one or more embodiments functions as an information processing apparatus, and includes the confirming portion 55 that confirms safety of a program in regards to computer viruses, the risk estimating portion 53 that estimates whether a program has a risk of causing infection with a computer virus, and the determining portion 57 that determines whether a function is to be executed based on one or more processes defined by the function in the case where execution of the function defining a program or a combination of programs is requested, and a program that is confirmed to be safe by the confirming portion 55 and is estimated to be risky by the risk estimating portion 53 is present among one or more programs defined by the function. In the case where the process defined by a function has no possibility of causing infection with a computer virus or has no possibility of causing infection to spread, even when the function is executed, the MFP 100 does not become infected with a computer virus or the infection with a computer virus does not spread. Therefore, even in the case where a program that is estimated to carry a risk of causing infection with a computer virus is present among the one or more programs defined by the function, the function can be executed. As a result, the MFP 100 can execute the function while avoiding a risk of computer viruses.

Further, the MFP 100 determines not to execute a function in the case where the one or more processes defined by the function include a process of a predetermined type. The process of the predetermined type is a process of a prohibited type and includes a process that may cause infection with a computer virus and may cause infection to spread. In the case where the one or more processes defined by the function include a prohibited process, the function is not to be executed. Therefore, a risk of causing infection with a computer virus or a risk of causing infection with a computer virus to spread can be avoided.

Further, a process that may cause infection with a computer virus to spread includes a process of outputting data to outside. Since a computer to which the data is output may become infected with a computer virus when the data is output to outside, the risk of causing infection with a computer virus to spread can be avoided.

Further, a process that may cause infection with a computer virus includes a process of receiving data from outside. Since the MFP 100 may become infected with a computer virus by receiving data from outside, the risk of infection with a computer virus can be avoided.

Further, the MFP 100 executes a function in the case where one or more processes defined by the function do not include a process of the prohibited type. Therefore, it is possible to execute the function while avoiding a risk of computer viruses.

Further, in the case where one or more processes defined by a function include a process of the type the set function level of which is equal to or lower than a security level, the MFP 100 does not execute the function. Therefore, it is possible to give a higher priority to avoidance of a risk of computer viruses or give a higher priority to convenience of executing the function, depending on the security level.

Further, the MFP 100 determines whether computer virus definition data is updated before a risk is estimated. Therefore, because the computer virus definition data can be updated before a risk is estimated, a risk can be estimated using the latest computer virus definition data.

Further, in a period of time during which the update mode is set to the first mode, the MFP 100 determines whether computer virus definition data is updated at shorter intervals as compared to the period of time during which the update mode is set to the second mode. Therefore, in the case where a program estimated to be risky is present among the programs that are confirmed to be safe, computer virus definition data is updated at shorter intervals as compared to the case where such a program is not present. Thus, the period of time during which a function is not executable can be made as short as possible.

Although embodiments of the present invention have been described and illustrated in detail, the disclosed embodiments are made for purpose of illustration and example only and not limitation. The scope of the present invention should be interpreted by terms of the appended claims.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing apparatus comprising:
a hardware processor that:
confirms whether a program is registered in a whitelist;
estimates whether the program is risky of causing infection with a computer virus;
determines whether the program that has been confirmed as registered but estimated as risky is present in a function requested by a user; and
upon determining that the program that has been confirmed as registered but estimated as risky is present in the function, determines whether to execute the function based on one or more processes defined by the function.

2. The information processing apparatus according to claim 1, wherein
upon determining that the one or more processes defined by the function include a process of a predetermined type, the hardware processor determines not to execute the function.

3. The information processing apparatus according to claim 2, wherein
the process of the predetermined type includes outputting data to outside.

4. The information processing apparatus according to claim 2, wherein
the process of the predetermined type includes receiving data from outside.

5. The information processing apparatus according to claim 2, wherein
upon determining that the one or more processes defined by the function do not include a process of the predetermined type, the hardware processor determines to execute the function.

6. The information processing apparatus according to claim 2, wherein
the hardware processor further:
sets function levels that respectively correspond to a plurality of processes of types;
sets a security level; and
upon determining that the one or more processes defined by the function include, among the processes of types, a process of a type whose function level is set to be equal to or lower than the security level, determines not to execute the function.

7. The information processing apparatus according to claim 1, wherein
the hardware processor estimates whether the program is risky based on computer virus definition data acquired from outside, and determines whether to update the computer virus definition data before estimating whether the program is risky.

8. The information processing apparatus according to claim 1, wherein
the hardware processor further:
estimates whether the program is risky based on computer virus definition data acquired from outside;
sets an update mode to a first mode for a program estimated as risky, and sets the update mode to a second mode different from the first mode for a program having been estimated as risky but estimated as not risky after updating the computer virus definition data; and
in a period of time during which the first mode is set, determines whether to update the computer virus definition data at shorter intervals as compared to intervals in a period of time during which the second mode is set.

9. A function executability determination method of causing an information processing apparatus to execute:
confirming whether a program is registered in a whitelist;
estimating whether the program is risky of causing infection with a computer virus;
determining whether the program that has been confirmed as registered but estimated as risky is present in a function requested by a user; and
upon determining that the program that has been confirmed as registered but estimated as risky is present in the function, determining whether to execute the function based on one or more processes defined by the function.

10. The function executability determination method according to claim 9, wherein
upon determining that the one or more processes defined by the function include a process of a predetermined type, the determining includes determining not to execute the function.

11. The function executability determination method according to claim 10, wherein
the process of the predetermined type includes outputting data to outside.

12. The function executability determination method according to claim 10, wherein
the process of the predetermined type includes receiving data from outside.

13. The information processing apparatus according to claim 10, wherein
upon determining that the one or more processes defined by the function do not include the process of the predetermined type, the determining includes determining to execute the function.

14. The function executability determination method according to claim 10, further including:
setting function levels that respectively correspond to a plurality of processes of types; and
setting a security level, wherein
upon determining that the one or more processes defined by the function include, among the processes of types, a process of a type whose function level is set to be equal to or lower than the security level, the determining includes determining not to execute the function.

15. The function executability determination method according to claim 9, wherein
the estimating includes estimating whether the program is risky based on computer virus definition data acquired from outside and determining whether to update the computer virus definition data before estimating whether the program is risky.

16. The function executability determination method according to claim 9, wherein
the estimating includes estimating whether the program is risky based on computer virus definition data acquired from outside,
the method further includes:
setting an update mode to a first mode for a program estimated as risky, and setting the update mode to a second mode different from the first mode for a program having been estimated as risky but estimated as not risky after updating the computer virus definition data, and
in a period of time during which the first mode is set, the estimating includes determining whether to update the computer virus definition data at shorter intervals as compared to intervals in a period of time during which the second mode is set.

17. A non-transitory computer-readable recording medium encoded with a function executability determination program for causing a computer to execute:
confirming whether a program is registered in a whitelist;
estimating whether the program is risky of causing infection with the computer virus;
determining whether the program that has been confirmed as registered but estimated as risky is present in a function requested by a user; and
upon determining that the program that has been confirmed as registered but estimated as risky is present in the function, determining whether to execute the function based on one or more processes defined by the function.
